(19) United States
(12) Patent Application Publication
(10) Pub. No.: US 2007/0214239 A1
(43) Pub. Date: Sep. 13, 2007

(54) Dynamically updated web page

(76) Inventors: Chavdar Blagoev Mechkov, Sofia (BG); Vladimir Stoyanov Enchev, Sofia (BG)

Correspondence Address: FISH & RICHARDSON PC, P.O. BOX 1022, MINNEAPOLIS, MN, 55440-1022, US

(21) Appl. No.: 11/373,539

(22) Filed: Mar. 10, 2006

(51) Int. Cl. G06F 15/16

(52) U.S. Cl. 709/219

(57) ABSTRACT

Among other things, in response to interaction of a user with a web page, a portion of the web page is updated, the portion being less than the entire web page, in a manner such that hidden values of the web page are consistent with non-hidden values of the web page.

### BACKGROUND

One way a computer user can interact with another, remote computer is by receiving files, over a network such as the world wide web. Files transferred over the world wide web are often referred to as “web pages,” or just “pages.” Web pages can be written in a variety of languages, including hypertext markup language (HTML), eXtensible HyperText Markup Language (XHTML), etc. Additionally, a web page written in HTML can be automatically generated by another file, known as an active server page. One way to author an active server page is using a collection of tools known as ASP.NET, which are available from Microsoft Corporation. An active server page typically has a variety of “controls,” with some controls corresponding to HTML elements of a web page.

### SUMMARY

In general, in one aspect, in response to interaction of a user with a web page, updating a portion of the web page, the portion being less than the entire web page, in a manner such that hidden values of the web page are consistent with non-hidden values of the web page.

Implementations may include one or more of the following features. Hidden values include a ViewState of the web page. Hidden values include an EventValidation of the web page. Non-hidden values include a content of the web page. A life cycle of the web page remains undisturbed during updating. Updating includes generating, on a server serving the web page, new source code corresponding to the portion of the web page. The portion has pre-update source code, and the method also includes causing the pre-update source code to be replaced by the new source code. Interaction of a user with the web page includes interaction with another portion of the web page, the other portion being disjoint from the first portion of the web page. Updating includes generating, on a server serving the web page, new source code corresponding to the portion of the web page, the source code being generated based on the interaction of the user with the other portion of the web page. The web page is generated from an active server page. The active server page is authored using ASP.NET. Verifying the user is not a web-crawler.

In general, in one aspect, on a server with an active server page having server controls, adding computer code for a requestor program to a server control of the active server page, the requestor program capable of generating formatted requests, configuring a server control to cause the requestor program to be executed, and adding a receiver program to the server, the receiver program capable of receiving formatted requests.

Other aspects include other combinations of the features recited above and other features, expressed as methods, apparatus, systems, program products, and in other ways. Other features and advantages will be apparent from the description and from the claims.

### DESCRIPTION

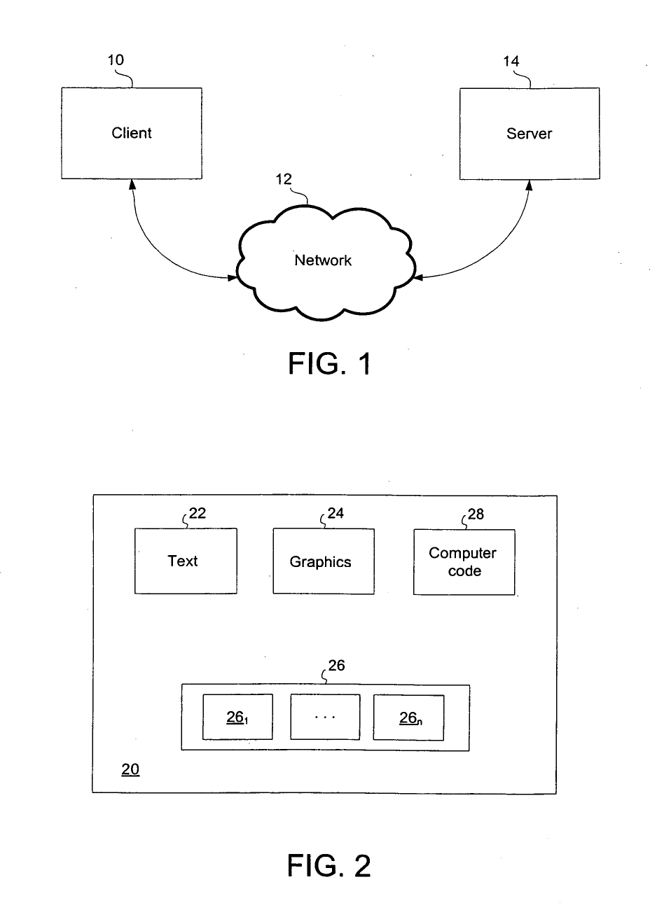

FIG. 1 is a block diagram of a computer connected to a server across a network.

FIG. 2 is a diagram of a web page.

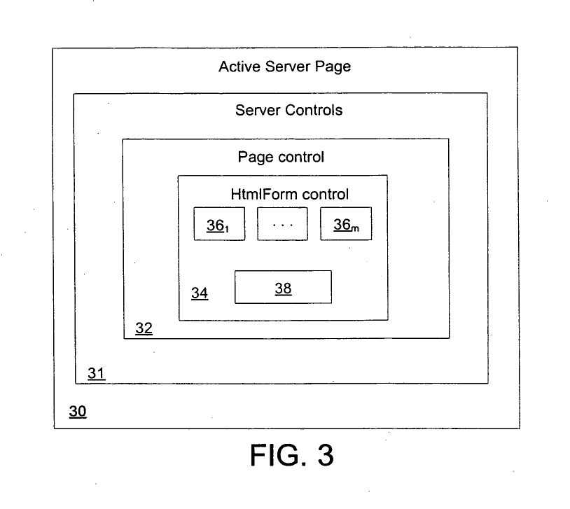

FIG. 3 is a diagram of an active server page in ASP.NET.

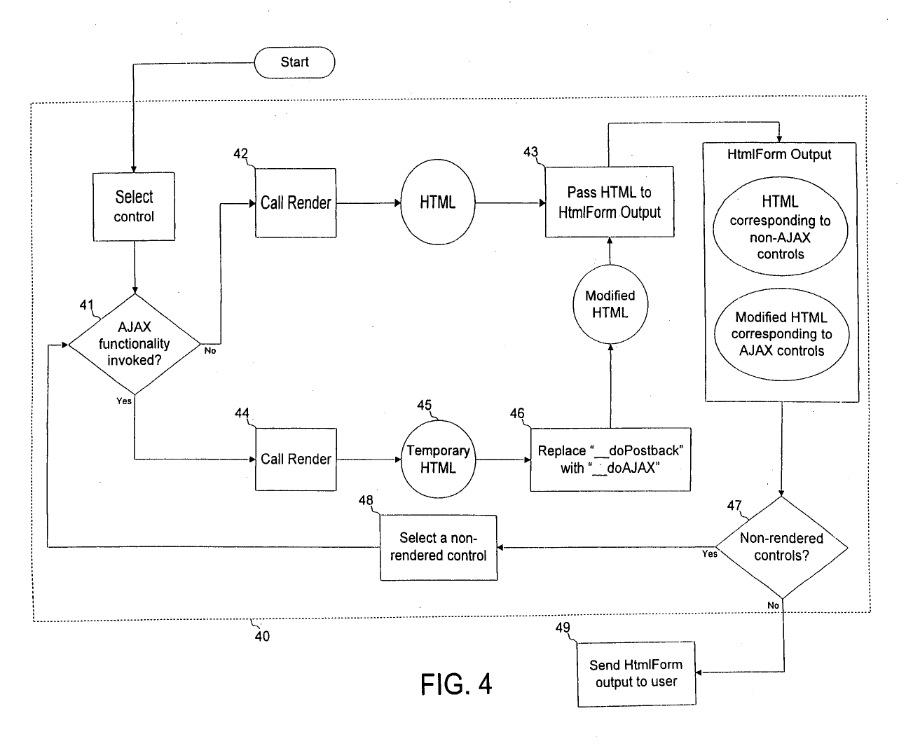

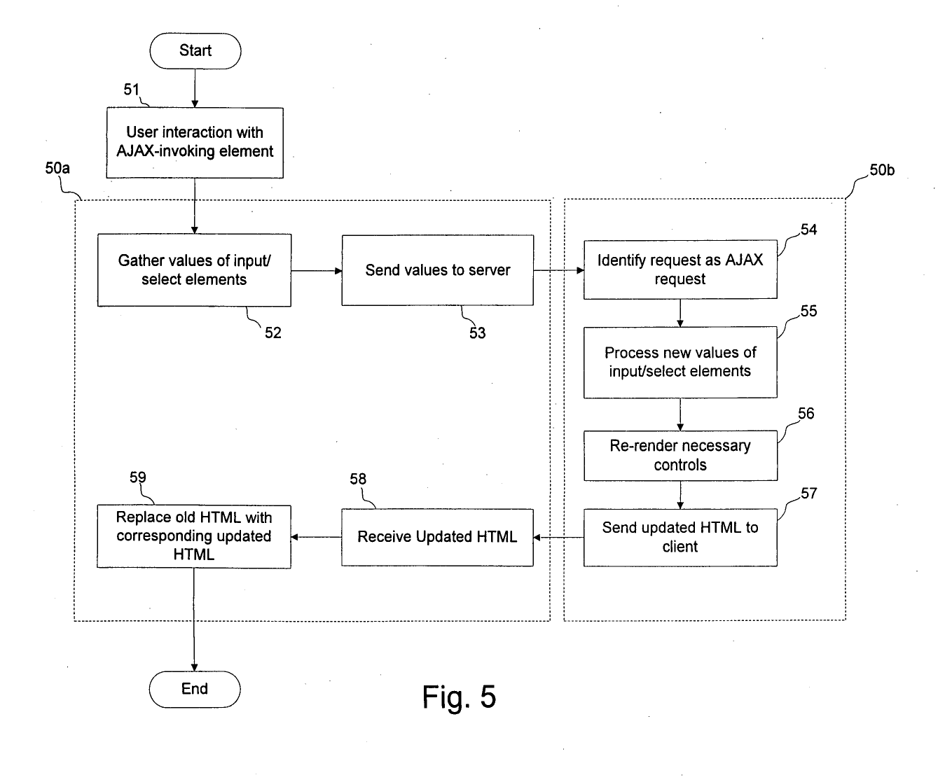

FIGS. 4 and 5 are flowcharts.

Referring to FIG. 1, a client computer 10 is connected to a server 14 across a network 12. The network 12 may be a local area network (LAN), a wide area network (WAN), or any other kind of network such as the Internet. A web browser running on the client 10 responds to user interaction with a web page, by sending requests to the server 14. The server typically responds to each request by serving an appropriate web page back to the client 10, where it is displayed using the web browser.

FIG. 2 is a schematic illustration of a typical web page 20 that the server 14 serves to the client 10. The web page 20 will be described as being written in HTML, but other variants of HTML such as XHTML may be used. The web page 20 contains elements such as text 22, graphics 24, a form 26, and computer code 28. Computer code 28 need not be visible to the user in a typical use of the page. In some implementations, the browser software running on the client 10 can display the content of and execute programs contained in the web page 20. For example, the browser may be able to execute programs written in the language JavaScript, and may have Active-X functionality.

The form 26 contains sub-elements 26₁, . . . , 26ₙ. Some of these sub-elements 26₁, . . . , 26ₙ may be modified by the user. Modifiable elements include “input” elements such as textboxes, etc. and “select” elements such as pull-down menus, check boxes, etc. The modifiable sub-elements can provide the web page 20 with a degree of interactivity: after the user interacts with a given element (e.g., clicks a button or changes the value of a text box), a user may receive additional information from the server 14 based on the user's action. Generally, sub-elements 26₁, . . . , 26ₙ need not be modifiable, and may be any type of element found outside the form 26, such as text, graphics, or computer code.

In ASP.NET embodiments, typically the web page 20 will have only one form 26, and the sub-elements 26₁, . . . , 26ₙ will account for substantially the entire content of the web page 20. (Relatively minor features of the web page 20, such as meta-data (if any) and the title (if any) of the web page 20 are not included in the form 26.) In these implementations, a user interaction with the form 26 is synonymous with user interaction with the web page 20. Reference to user interaction with the form 26 refers to these embodiments, unless otherwise specified.

Referring to FIG. 3, when the web page 20 is generated using ASP.NET, there is an active server page 30 that contains instructions for generating the web page 20 (or portions of the web page 20). The active server page 30 is a file or group of files that resides on the server 14. When a request arrives from a browser, the server 14 can use the active server page 30 to dynamically generate content to be served back to the client 10 in response to the request. The active server page 30 has a variety of server controls 31. Some server controls 31 allow the author of the active server page 30 to organize its constituent parts. For example, the Page control 32 is a server control in which names of other server controls are collected. Within the Page control 32, there is an HtmlForm control 34. Names of controls which interact with the server 14 (as described more fully below) are collected in the HtmlForm control 34. Each server control 36₁, . . . , 36ₘ named in the HtmlForm control 34 generally corresponds with an element of the web page 20.

Any of the server controls 36₁, . . . , 36ₘ may be linked with any of the other server controls 36₁, . . . , 36ₘ. For example 36₁ may be linked with 36₂. By linked we mean, for example, that when the user interacts with an element corresponding to control 36₁ (for example, suppose 36₁ corresponds to element 26₁) then such interaction will affect the element corresponding to control 36₂ (say, for example, element 26₂) For example, element 26₁ may be a pull-down menu listing months of the year, and element 26₂ may be a pull-down menu indicating the days of the month selected in the element 26₁. Thus, if “January” is selected in the element 26₁, then element 26₂ may be a pull-down menu having the values 1-31. If “November” is selected in element 26₁, then element 26₂ may be a pull-down menu having the values 1-30.

As another example, control 36₁ may correspond to an area of the web page and control 36₂ may correspond to another area of the web page displaying graphics. Control 36₁ may be linked to control 36₂ so that when the user moves the mouse over the area of the web page corresponding to control 36₁, the graphics corresponding to control 36₂ change.

The server controls 31 also include an AJAX engine server control 38. As described more fully below, the AJAX engine server control 38 corresponds to an AJAX engine that mediates the interaction between the client 10 and server 14.

Often a web page will reload after the user interacts with the web page. For example if the web page has an area for user input and the web page is generated by traditional ASP.NET techniques, the web page will perform a “Submit” command, also known as “Postback,” which causes the web page to be completely regenerated on the server, taking into account the input of the user. If the web page contains a relatively large amount of graphics or other data, or if the network connection is relatively slow, serving the revised web page can take an undesirably long time. To reduce the delay, the web page 20 may be generated in such a way that some or all of the elements of the form 26 are dynamically updated independently of the rest of the web page 20. When the web page 20 is generated using ASP.NET techniques discussed below, the “Postback” is not used and refreshing of the page at the user's browser is quicker.

When authoring the active server page 30 using ASP.NET, some or all of the server controls (except the AJAX engine server control 38) can be selected by the author to invoke AJAX functionality. Invoking AJAX functionality, as described more fully below, causes selected elements of the form 26 to be dynamically updated without requiring reloading the full web page 20.

In response to an initial request from a user, the active server page 30 will generate a web page 20. In a traditional ASP.NET implementation, each server control generated at the server by a “Render” method. In some implementations described here, the “Render” method is replaced by a modified method. The replacement may be made using the SetRenderMethodDelegate command in ASP.NET implementations. The “Render” method of the Page control 32 is replaced with a modified method denoted CustomPageRender, and the “Render” method of the HtmlForm control 34 is replaced with a modified method denoted CustomHtmlFormRender. When invoked, the CustomPageRender method cycles through any controls that are outside the HtmlForm 34 and generates a corresponding portion of HTML code and JavaScript that implement the given control in the web page 20.

FIG. 4 shows a loop 40 performed by the CustomHtmlFormRender command. When invoked, the CustomHtmlFormRender command cycles through each of the server controls 31 in the HtmlForm 34 and generates a corresponding portion of HTML code and/or JavaScript that implements the given control in the web page 20. The portions of the HTML code for all of the controls are ultimately assembled to form the complete web page 20.

For a given page control, the CustomHtmlFormRender method determines whether the control invokes AJAX functionality (step 41). If a given control does not invoke AJAX functionality, the CustomHtmlFormRender method simply calls the original Render method of the control (step 42). The original Render method generates a portion of HTML corresponding to the given control and passes the HTML to the HtmlForm output (step 43). On the other hand, if a given control does invoke AJAX functionality, the CustomHtmlFormRender method first calls the traditional Render method (step 44), and stores the output of the original Render method in a temporary Output object of class HtmlTextWriter (step 45). CustomHtmlFormRender then replaces each instance of the text string “_doPostback” with a custom text string, for example “_doAJAX” (step 46). (As explained more fully below, the _doAJAX command initiates the dynamic update via the AJAX engine.) CustomHtmlFormRender then passes the “modified” HTML code produced by step 46 to the HtmlForm output (step 43).

CustomHtmlFormRender determines whether there are any other controls which have not been rendered (step 47). If so, a non-rendered control is selected (step 48) and rendered as described above. If all controls have been rendered, then the HtmlForm output is complete, and is served (step 49) to the client 10 as the web page 20.

The AJAX engine server control 38 contains computer code. Some of the computer code is written in a Microsoft .NET Framework-compatible language and is executed on the server. This is referred to as “server-side AJAX engine.” The rest of the code is written in a cross-browser client scripting language, typically JavaScript. When the AJAX engine server control 38 is rendered by the CustomHtmlFormRender command, the client-side code will be incorporated into the HTML code for the web page 20. Additionally, the CustomHtmlFormRender command provides this client-side code with two pieces of information: the uniform resource locator (URL) of the web page 20 and the ClientID of the AJAX engine server control 38. When the web page 20 is viewed by the user, the client-side code is executed. The executed code creates part of the AJAX engine, referred to as the “client-side AJAX engine” which resides on the client 10.

FIG. 5 illustrates the dynamic updating of a form 26, and the interaction of the client-side AJAX engine 50a and the server-side AJAX engine 50b. In this diagram, it is assumed that a user of the client 10 has loaded the web page 20 has interacted with a given element (clicks a button, changes the value of a text box) that typically initiates a Postback. It is also assumed that the client-side AJAX engine is loaded.

After the user interacts with an element of the web page 20 that invokes AJAX functionality (step 51), the _doAJAX command is called, which in turn activates the client-side AJAX engine 50a. We shall suppose the user interacted with element 26, although any element may invoke AJAX functionality. The client-side AJAX engine 50a gathers all values of the input elements select elements in the web page 20 (step 52). These values are sent to the server-side AJAX engine 50b (step 53), so that they can be used for server-side processing as if a normal Postback is taking place. Sending these values to the server-side AJAX engine 50b results in advantageous preservation of characteristics of the web page 20, such as the ViewState, Event Validation, and page life cycle. Preservation of these characteristics is discussed more fully below.

The client-side AJAX engine also passes identifying information about the element 26, such as its UniqueID, to the server. When the server-side AJAX engine 50b identifies the request made by the _doAJAX command as an “AJAX request” (e.g., the request comes from the client-side AJAX engine 50a) (step 54), it processes the new values of “input” and “select” elements, if any (step 55) and re-renders all controls linked with the control corresponding to element 26 (step 56). These controls are re-rendered using the CustomHtmlFormRender method as described above. The new code is served back to the client-side AJAX engine 50a (step 57). When the client-side AJAX engine 50a receives the new HTML code (step 58), it replaces the old HTML code of the updated elements with the new HTML code it received.

In some implementations, in response to user interaction with an AJAX-invoking element, the client-side AJAX engine then creates a new object of type XmlHttpRequest. Next, the client-side AJAX 50a engine gathers the values of all input and select elements of the web page 20. The client-side AJAX engine calls the Open method of the XmlHttpRequest object, and provides as parameters: the URL of the web page 20, and the type of AJAX callback request (synchronous or asynchronous). Synchronous callbacks require that one AJAX request is complete before a new one can be initiated; asynchronous callbacks do not have this limitation. A third parameter, “Post”, is passed to the Open method of the XmlHttpRequest object. Additionally, the client-side AJAX begins monitoring the status and readyState of the XmlHttpRequest object, to determine when the request has been completed. The request is completed when the status equals 200 and the readyState equals 4. The client-side AJAX engine then calls the Send method of the XmlHttpRequest object, providing as parameters the ClientID of the AJAX engine server control 38, the UniqueID of the element which initiated the AJAX request, as well as the new values of the “input” and “select” elements of the form 26.

The server-side AJAX engine receives the request made by the XmlHttpRequest object. Initially, the server-side AJAX engine checks to ensure whether the request is an AJAX request by comparing the received ClientID to the ClientID of the AJAX engine server control 38. If the two IDs match, the request is identified as an AJAX request. The server-side AJAX engine then replaces the original Render methods of the Page control and the HtmlForm control with modified Render methods using the SetRenderMethodDelegate, as described above. The new CustomRender methods cycle through the Page and HtmlForm controls, and re-render all controls that are linked to the particular element that initiated the AJAX request. This element is received by the server-side AJAX engine 50b as a parameter from the client-side AJAX engine 50a). When all the necessary controls have been re-rendered, the HTML and optionally JavaScript code corresponding only to the updated controls is sent back to the XmlHttpRequest object on the client, causing the status of the XmlHttpRequest object to equal 200 and the readyState to equal 4.

When this occurs, the client-side AJAX engine obtains the new HTML and optionally JavaScript code by retrieving the value of the responseText property of the XmlHttpRequest object. The client-side AJAX engine replaces old HTML and optionally JavaScript code of the web page 20 with the new code obtained from the XmlHttpRequest object, and replaces old values of input elements, and hidden fields with the new values received. Finally, the client-side AJAX engine executes any JavaScript code the updated form elements may have, to ensure that elements with functionality implemented through JavaScript are properly initialized, as if a traditional Postback had taken place.

As noted above, dynamically updating the web page 20 in this fashion avoids the use of the Postback command, which can result in undesirable wait times. There are other advantages of dynamically updating the web page 20 as described above.

In some implementations, the various features of the web page 20, e.g. JavaScript programs, need not be modified to account for the above dynamic update procedure. In particular, programs which rely on traditional Postback commands need not be modified. Thus, it is relatively easy to convert a traditional web page to a dynamically updated web page 20. For example, if the traditional web page is generated using ASP.NET, then it may be converted to a dynamically updated web page 20 by including an AJAX engine control in the HtmlForm control, and specifying which HtmlForm controls will initiate AJAX request and which controls will be dynamically updated.

Depending on how a traditional web page is authored, there is typically a known sequence of steps that generally occur when the web page is requested by the client. The known sequence of steps is referred to as the life cycle of the page. Generally, steps in the life cycle involve receiving the request from the client 10, generating the web page, and delivering the web page to the client. When a web page 20 is dynamically updated as described above, the normal life cycle of the web page 20 is not changed. Maintaining the normal life cycle of the web page 20 results in relatively fewer errors for programs contained in the web page 20. Similarly, maintaining the normal lifecycle of the web page 20 contributes to relatively broad applicability and relatively easy implementation of dynamically updating the web page 20 as described above.

In some implementations, when the web page 20 is dynamically updated as described above, its ViewState and EventValidation continuously take into account the dynamic updating. The ViewState and EventValidation are hidden values in the HTTP code of the web page 20, and keep track of several features of the web page 20 and the user's interaction with the web page 20. Some traditional ways of dynamically updating a web page do not maintain the ViewState and EventValidation to reflect every update in a timely way. Differences between the ViewState/EventValidation of the page and the content of the page (i.e., the displayed text, graphics, etc.) can lead to errors. Such errors are reduced when the web page 20 is dynamically updated as described above.

Dynamically updating the web page 20 can be implemented in harmony with web crawlers. Web crawlers are programs which repeatedly load, index, and store the content of web pages in a central location. For example, many search engines employ web crawlers to compose a database of searchable pages. It is common for a web crawler that requests a web page from a server 14 to identify itself as a web crawler.

In some implementations, new HTML code corresponding to dynamically updated features of the web page 20 is stored in the memory of the client 10. Such a scenario prevents some web crawlers from accessing dynamically updated content. Thus, in some implementations, if the server 14 determines that a web crawler is requesting access to the active server page 30, the request is not processed as described above. Instead, the AJAX engine generates static HTML instead of dynamically updated HTML. These implementations allow web crawlers to index content which would otherwise be dynamically updated for non-web crawler requestors.

Other embodiments are within the scope of the following claims.

What is claimed is:

1. A method comprising:
In response to interaction of a user with a web page, updating a portion of the web page, the portion being less than the entire web page, in a manner such that hidden values of the web page are consistent with non-hidden values of the web page.

2. The method of claim 1 in which hidden values include a ViewState of the web page.

3. The method of claim 1 in which hidden values include an EventValidation of the web page.

4. The method of claim 1 in which non-hidden values include a content of the web page.

5. The method of claim 1 in which a life cycle of the web page remains undisturbed during updating.

6. The method of claim 1 in which updating includes generating, on a server serving the web page, new source code corresponding to the portion of the web page.

7. The method of claim 6 in which the portion has pre-update source code, and the method also includes causing the pre-update source code to be replaced by the new source code.

8. The method of claim 1 in which interaction of a user with the web page includes interaction with another portion of the web page, the other portion being disjoint from the first portion of the web page.

9. The method of claim 8 in which updating includes generating, on a server serving the web page, new source code corresponding to the portion of the web page, the source code being generated based on the interaction of the user with the other portion of the web page.

10. The method of claim 1 in which the web page is generated from an active server page.

11. The method of claim 10 in which the active server page is authored using ASP.NET.

12. The method of claim 1 also including verifying the user is not a web-crawler.

13. A method comprising:
On a server with an active server page having server controls, adding computer code for a requestor program to a server control of the active server page, the requestor program capable of generating formatted requests,
configuring a server control to cause the requestor program to be executed, and adding a receiver program to the server, the receiver program capable of receiving formatted requests.

14. A medium bearing instructions to cause an apparatus to:
update a portion of a web page in response to interaction of a user with the web page, the portion being less than the entire web page, in a manner such that hidden values of the web page are consistent with non-hidden values of the web page.

15. The medium of claim 14 in which hidden values include a ViewState of the web page.

16. The medium of claim 14 in which hidden values include an EventValidation of the web page.

17. The medium of claim 14 in which non-hidden values include a content of the web page.

18. The medium of claim 14 in which a life cycle of the web page remains undisturbed during updating.

19. The medium of claim 14 in which updating includes generating, on a server serving the web page, new source code corresponding to the portion of the web page.

20. The medium of claim 19 in which the portion has pre-update source code, and the method also includes causing the pre-update source code to be replaced by the new source code.

21. The medium of claim 1 in which interaction of a user with the web page includes interaction with another portion of the web page, the other portion being disjoint from the first portion of the web page.

22. The medium of claim 21 in which updating includes generating, on a server serving the web page, new source code corresponding to the portion of the web page, the source code being generated based on the interaction of the user with the other portion of the web page.

23. The medium of claim 14 in which the web page is generated from an active server page.

24. The medium of claim 23 in which the active server page is authored using ASP.NET.

25. The medium of claim 14 in which the instructions also include instructions for verifying the user is not a web-crawler.

26. A medium bearing instructions to cause an apparatus to:
On a server with an active server page having server controls, add computer code for a requestor program to a server control of the active server page, the requestor program capable of generating formatted requests,
configure a server control to cause the requestor program to be executed, and add a receiver program to the server, the receiver program capable of receiving formatted requests.
